(19) United States
(12) Patent Application Publication
(10) Pub. No.: US 2017/0357238 A1
(43) Pub. Date: Dec. 14, 2017

(54) METHOD AND SYSTEM FOR GAUGING AND AUTO CORRECTING GEOMETRIC TOLERANCES

(71) Applicant: Marshall Machines (P) Ltd., Ludhiana (IN)

(72) Inventors: Gaurav SARUP, Ludhiana (IN); Prashant SARUP, Ludhiana (IN); Siddhant SARUP, Ludhiana (IN)

(73) Assignee: Marshall Machines (P) Ltd., Ludhiana (IN)

(21) Appl. No.: 15/194,590

(22) Filed: Jun. 28, 2016

(30) Foreign Application Priority Data
Jun. 8, 2016 (IN) 2016/11019606

(51) Int. Cl. G05B 19/402

(52) U.S. Cl. CPC G05B 19/402; G05B 2219/42195; G05B 2219/37582

(57) ABSTRACT

A system and method for gauging and auto correcting geometric tolerances in respect of a work piece is disclosed. The method includes receiving and storing one or more desired in respect of a first work piece from a user. The method further includes measuring one or more desired in respect of a second work piece; comparing the measured one or more desired in respect of the second work piece with the corresponding stored one or more desired and assessing, existence of a deviation within a predetermined tolerance range in one or more desired measured in respect of the second work piece based on comparison. Thereafter, the method involves auto-correcting one or more desired in respect of the second work piece based on identified deviation, such that the corrected one or more geometric tolerance values in respect of the second work piece is equivalent to stored one or more desired.

### FIELD OF THE INVENTION

The present invention relates to computerized numerical control (CNC) machines and in particularly relates to method and device connected to CNC machines for gauging and auto correcting geometric tolerances in respect of a work piece.

### BACKGROUND OF THE INVENTION

Manufacturing processes typically result in product variation. Product variation is the result of one or more of a number of factors including variations in material, variations in the environment, and worn equipment. When the product variation exceeds certain levels the product is defective, resulting in either scrap or the necessity to rework the product. This results in huge cost to the manufacturers.

Further, to comply with the requirements of modern high-precision machine tool, the accurate measurements become absolutely necessary. Accordingly, it becomes important to detect the possible defects at an appropriate time and take appropriate corrective measures.

Generally, the operator is responsible for the correct running of the machine. The operator would load/unload the parts and check manually with analog devices like airgauges, micro meters etc. Here, the main hurdle is of uneducated operators who do not have interest in running the machine. Also the operators are underpaid and hence there is lack of motivation to learn and do their job thoroughly. Also, the frequency of these mistakes is especially high during the night shift when the operators have the tendency to be lazy. For the quality check, there are inspectors who would check all the components 100% with the help of gauges right before the dispatch. They would act as a safety net and make sure defectives do not go to the end customer. The quality controlled is generally performed by humans and there exists a probability of rejection and re-work which result in ultimately loss to the company.

Thus, there exists a need to for automated systems which monitor parts/work pieces and products produced, measure the uniformity, and provide alerts when parts are out of tolerance.

### SUMMARY OF THE INVENTION

In an embodiment, a method for gauging and auto correcting geometric tolerances in respect of a work piece is disclosed. The method includes receiving one or more desired/standard geometric tolerance values in respect of a first work piece from a user and storing said one or more desired/standard geometric tolerances values in respect of the first work piece. The method further includes measuring one or more geometric tolerance values in respect of a second work piece; comparing the measured one or more geometric tolerance values in respect of the second work piece with the corresponding stored one or more desired/standard geometric tolerance values and assessing existence of a deviation/variation within a predetermined tolerance range in said one or more geometric tolerance values measured in respect of the second work piece based on comparison. Thereafter, the method involves auto-correcting one or more geometric tolerance values in respect of the second work piece based on identified deviation/Variation in the event of existence of a deviation/variation in within a predetermined tolerance range in said one or more geometric tolerance values in respect of the second work piece based on comparison, such that the corrected one or more geometric tolerance values in respect of the second work piece is equivalent to stored one or more desired/standard geometric tolerances.

In an embodiment, an system connected to a CNC machine for ganging and auto correcting geometric tolerances in respect of a work piece is provided. The system includes an input means for receiving one or more desired/standard geometric tolerance values in respect of a first work piece from a user and a memory for storing said one or more desired/standard geometric tolerances values in respect of the first work piece. The system is further provided with a processor which in operational interconnection with one or more digital probes is configured for: measuring one or more geometric tolerance values in respect of a second work piece; comparing the measured one or more geometric tolerance values in respect of the second work piece with the corresponding stored one or more desired/standard geometric tolerance values; and assessing existence of a deviation/variation within a predetermined tolerance range in said one or more geometric tolerance values measured in respect of the second work piece based on comparison. The system further includes a correction unit for auto-correcting one or more geometric tolerance values in respect of the second work piece based on identified deviation/variation in the event of existence of a deviation/variation in within a predetermined tolerance range in said one or more geometric tolerance values in respect of the second work piece based on comparison, such that corrected one or more geometric tolerance values in respect of the second work piece is equivalent to stored one or more desired/standard geometric tolerances.

An object of the present invention is to ensure that the human error involved while testing the products/tools/work pieces is eliminated.

An object of the present invention is to ensure that the CNC machines can be run by humans with minimal defects.

An object of the present invention is to ensure that the dependency on humans for testing is minimized.

An object of the present invention is to provide information of the defects to proper personnel on a timely basis and take appropriate corrective measures.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will he described and explained with additional specificity and detail with the accompanying drawings.

### BRIEF DESCRIPTION OF FIGURES

These and other features, aspects, and advantages of the present invention will become better understood when the following detailed description is read with reference to the accompanying drawings in which like characters represent like parts throughout the drawings, wherein:

FIG. 1 shows a flow chart for a method for gauging and auto correcting geometric tolerances in respect of a work piece system in accordance with an embodiment of the invention;

FIG. 2 shows an system for gauging and auto correcting geometric tolerances in respect of a work piece system in accordance with an embodiment of the invention;

FIG. 3 shows a flow chart for an exemplary implementation in accordance with an embodiment of the invention;

FIG. 4A and FIG. 4B shows an exploded view of the gauging station along with the part numbers and quantity in accordance with an embodiment of the invention;

FIG. 5 shows the front view of the gauging station as shown in FIG. 4A in accordance with an embodiment of the invention;

FIG. 6 shows the right side view of the ganging station as shown in FIG. 4 in accordance with an embodiment of the invention:

FIG. 7 shows the left side view of the gauging station as shown in FIG. 4A in accordance with an embodiment of the invention:

FIG. 8 shows the backside view of the gauging station as shown in FIG. 4A in accordance with an embodiment of the invention;

FIG. 9 shows the isometric view of the gauging station as shown in FIG. 4A in accordance with an embodiment of the invention;

FIG. 10 illustrates a typical hardware configuration of a computer system, which is representative of a hardware environment for practicing the present invention.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same, it will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub systems or elements or structures or components proceeded by “comprises . . . a” does not, without more constraints, preclude the existence of other devices or other sub-systems or other elements or other structures or other components or additional devices or additional stub systems or additional elements or additional structures or additional components.

Unless otherwise defined, all technical and scientific terms used herein have the same meaning as commonly understood by one of ordinary skill in the it to which this invention belongs. The system, methods, and examples provided herein are illustrative only and not intended to be limiting.

Embodiments of the present invention will be described below in detail with reference to the accompanying drawings.

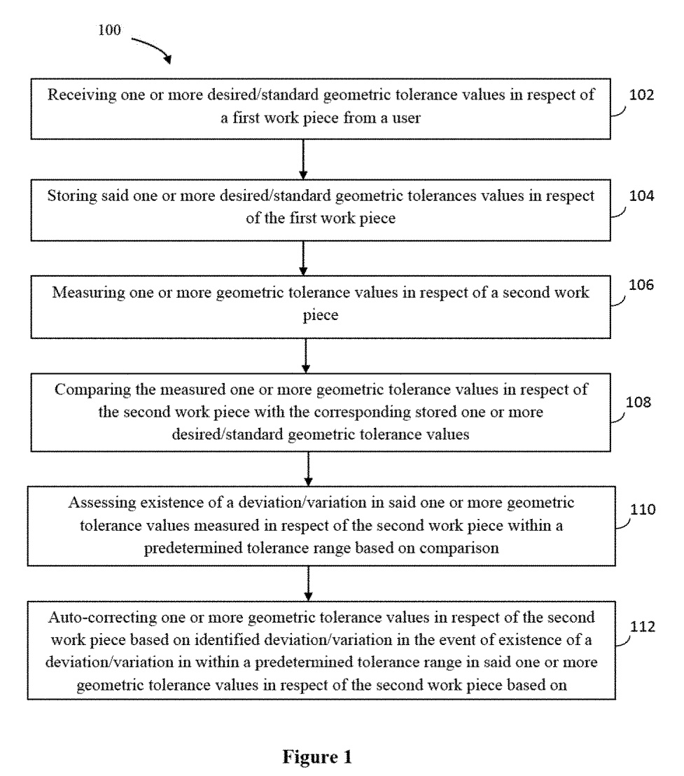

FIG. 1 illustrates a method 100 for gauging and auto correcting geometric tolerances in respect of a work piece. The method 100 includes step 102 of receiving one or more desired/standard geometric tolerance values in respect of a first work piece from a user using an input device and step 104 of storing said one or more desired standard geometric tolerances values in respect of the first work piece. The first piece is generally referred to as the Master Piece and the second piece used herein is generally referred to as the Production Piece. The method 100 further includes step 106 of measuring one or more geometric tolerance values in respect of a second work piece; step 108 of comparing the measured one or more geometric tolerance values in respect of the second work piece with the corresponding stored one or more desired/standard geometric tolerance values and step 110 of assessing existence of a deviation/variation within a predetermined tolerance range in said one or more geometric tolerance values measured in respect of the second work piece based on comparison. Thereafter, the method 100 involves step 112 auto-correcting one or more geometric tolerance values in respect of the second work piece based on identified deviation/variation in the event of existence of a deviation/variation in within a predetermined tolerance range in said one or more geometric tolerance values in respect of the second work piece based on comparison, such that the corrected one or more geometric tolerance values in respect of the second work piece is equivalent to stored one or more desired/standard geometric tolerances.

In an embodiment, the method 100 further includes sending a signal to the user in the event of existence of deviation/variation beyond said predetermined tolerance range in said one or more geometric tolerance values measured in respect of the second work piece.

In an embodiment, the more desired/standard geometric tolerance values are calculated by measuring and calculating a mean of geometric tolerance values associated with a plurality of similar first work pieces.

In an embodiment, the method 100 further includes calculating the correction value to be applied to one or more geometric tolerance values in respect of the second work piece based on identified deviation/variation.

In an embodiment, the predetermined tolerance range of deviation/variation is pre-stored. In another embodiment, the method 100 further includes the predetermined tolerance range is configured to be modified by the user.

In an embodiment, the method 100 further includes the geometric tolerance values include values relating to one or more of outer diameter, inner diameter, height, size, cross-sectional area, thread pitch, of in respect of work piece.

In an embodiment, the method 100 further includes storing in memory and displaying on a display one or more of:
e. the measured one or more geometric tolerance values in respect of the first second work piece;
f. results of comparison of the measured one or more geometric tolerance values in respect of the second work piece with the corresponding stored one or more desired/standard geometric tolerance values;
g. the correction value to be applied to one or more geometric tolerance values in respect of the second work piece based on identified deviation/variation.
h. log details pertaining to the measurement and comparison.

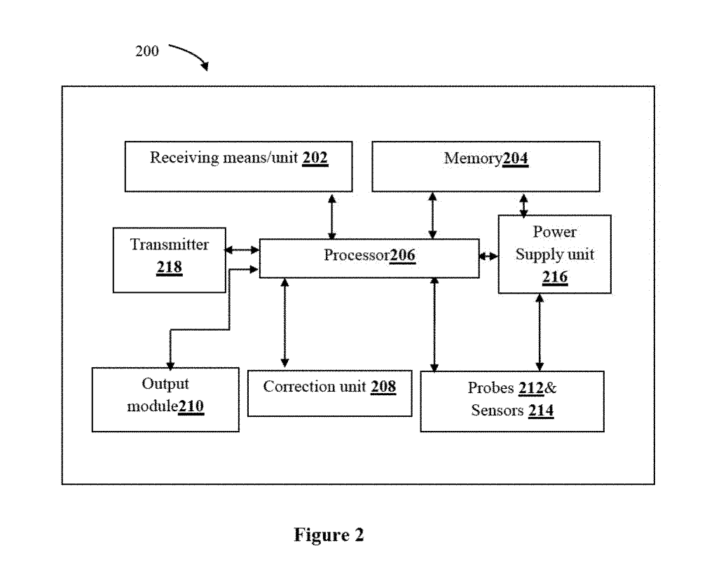

Referring to FIG. 2, an system 200 connected to a CNC machine for gauging and auto correcting geometric tolerances in respect of a work piece system in accordance with an embodiment of the invention is illustrated. The system 200 includes a receiving means/unit 202 for receiving one or more desired/standard geometric tolerance values in respect of a first work piece from a user and a memory 204 for storing said one or more desired/standard geometric tolerances values in respect of the first work piece. The system 200 is further provided with a processor 206 which in operational interconnection with one or more digital probes is configured for: measuring one or more geometric tolerance values in respect of a second work piece; comparing the measured one or more geometric tolerance values in respect of the second work piece with the corresponding stored one or more desired/standard geometric tolerance values; and assessing existence of a deviation/vacation within a predetermined tolerance range in said one or more geometric tolerance values measured in respect of the second work piece based on comparison. The system 200 further includes a correction unit 208 that comprises one or more microprocessors and processing algorithms for auto-correcting one or more geometric tolerance values in respect of the second work piece based on identified deviation/variation in the event of existence of a deviation/variation in within a predetermined tolerance range in said one or more geometric tolerance values in respect of the second work piece based on comparison, such that corrected one or more geometric tolerance values in respect of the second work piece is equivalent to stored one or more desired/standard geometric tolerances.

The system 200 further includes an output module 210 such as a display one or more of:
e. the measured one or more geometric tolerance values in respect of the first second work piece;
f. results of comparison of the measured one or more geometric tolerance values in respect of the second work piece with the corresponding stored one or more desired/standard geometric tolerance values;
g. the correction value to be applied to one or more geometric tolerance values in respect of the second work piece based on identified deviation variation.
h. log details pertaining to the measurement and comparison.

The memory 204 is further to store the measured one or more geometric tolerance values in respect of the first second work piece, results of comparison of the measured one or more geometric tolerance values in respect of the second work piece with the corresponding stored one or more desired/standard geometric tolerance values, the correction value to be applied to one or more geometric tolerance values in respect of the second work piece based on identified deviation/variation, log details pertaining to the measurement and comparison. The log details include date and time stamp on which the work piece was checked.

In an embodiment, the system 200 further includes one or more probes 212 including touch probes, digital probes including one or more of lasers.

In an embodiment, the system 200 further includes one or more sensors 214 including cameras, position sensors, pressure sensors, gauges etc. to sense placement of correct work piece.

In an embodiment, the system 200 further includes a power supply unit 216 for supplying power various components of the system 200.

In an embodiment, the system 200 further includes a transmitter 218 for transmitting a signal to the user in the event of existence of deviation/variation beyond said predetermined tolerance range in said one or more geometric tolerance values measured in respect of the second work piece. The signal is generally sent in the form of an alert message/notification and is displayed on the display.

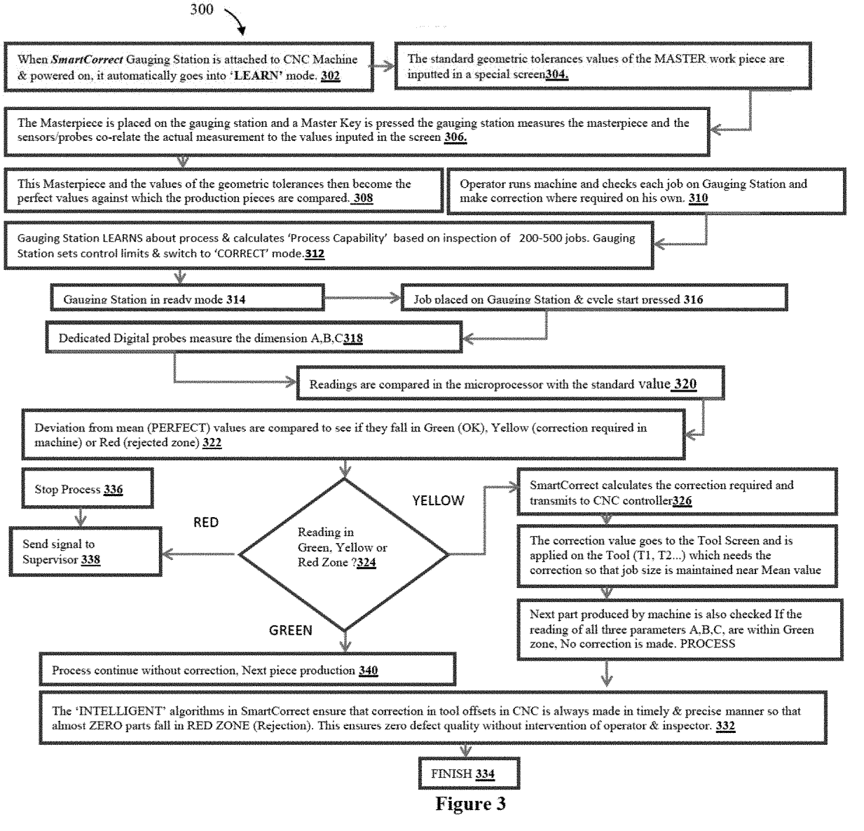

Referring to FIG. 3, a flow chart for an exemplary implementation in accordance with an embodiment of the invention is illustrated. The process 300 begins at step 303 when the gauging station (referred to as SmartCorrect) is attached to the CNC machine and powered on. Thereafter, the gauging station automatically goes into the Learn Mode. Initially, the standard geometric tolerances values of the MASTER work piece (first work piece) are inputted in a special screen as indicated in step 304. The Masterpiece is placed on the gauging station and a Master Key is pressed the gauging station measures the masterpiece and the sensors/probes co-relate the actual measurement to the values inputed in the screen as indicated in step 306. This Masterpiece and the values of the geometric tolerances then become the perfect values against which the production pieces are compared as indicated in step 308. The Operator runs machine and checks each job on Gauging Station and make correction where required on his own as indicated in step 310. The Gauging Station LEARNS about process & calculates the ‘Process Capability’ based on inspection of 200-500 jobs/work piece. Gauging Station sets control limits switches to ‘CORRECT’ mode as indicated in step 312. Thereafter, the gauging station runs in ready mode as indicated in step 314. The process continues and the new job/work piece is placed on the gauging station and the cycle start is pressed as indicated in block 316. Once the job (production piece) is placed on the gauging station, the probes including digital and touch probes measure the dimensions, for instance, outer diameter (A), inner diameter (B), Height (C) relating to the job as indicated in step 318. The measured readings are thereafter compared, at step 320, by the microprocessor with the standard mean values set during the CORRECT mode. The deviations are identified and checked if they fall outside or within a predetermined acceptable range as fixed by the operator at step 322. Generally, three zones have been exemplified in the present invention. The red zone indicates that the deviations are beyond the predetermined tolerance range, the yellow zone indicates the deviations are within the predetermined tolerance range and green zone indicates that there are no deviations. The system thereafter at checks the nature of zone at step 324. If the deviations are found to be within the yellow zone. the SmartCorrect calculates the correction required and transmits to CNC controller at step 326 The correction. value goes to the Tool Screen and is applied on the Tool (T1, T2, . . . ) which needs the correction so that job size is maintained near Mean value as indicated in step 328. Thereafter, at step 330 and 332, the next part produced by the machine is also checked and if the readings of all three parameters A,B,C, are found to be without any deviation from the standard value (i.e. within Green zone)and no correction is made and process continues. The ‘INTELLIGENT’ algorithms in SmartCorrect ensure that correction in tool offsets in CNC is always made in timely & precise manner so that almost ZERO parts fall in RED ZONE (Rejection). This ensures zero defect quality without intervention of operator & inspector. The process thereafter finishes at step 334. If at step 324, the deviations are found to be in the Red zone, the process is stopped at step 336 and a signal is sent at step 338 to the supervisor to take appropriate corrective action. If at step 324, the deviations are found to be in the Green zone, the process continues without correction and thereafter the next piece is produced and checked as indicated in step 340. Thus, it may be noticed that the above system and process provides the following advantages: make 100% ok parts, provides real time records of all the parts produced, eliminate human error, eliminate dependency on humans for quality, ensures that the machines can be run by unskilled and uneducated people.

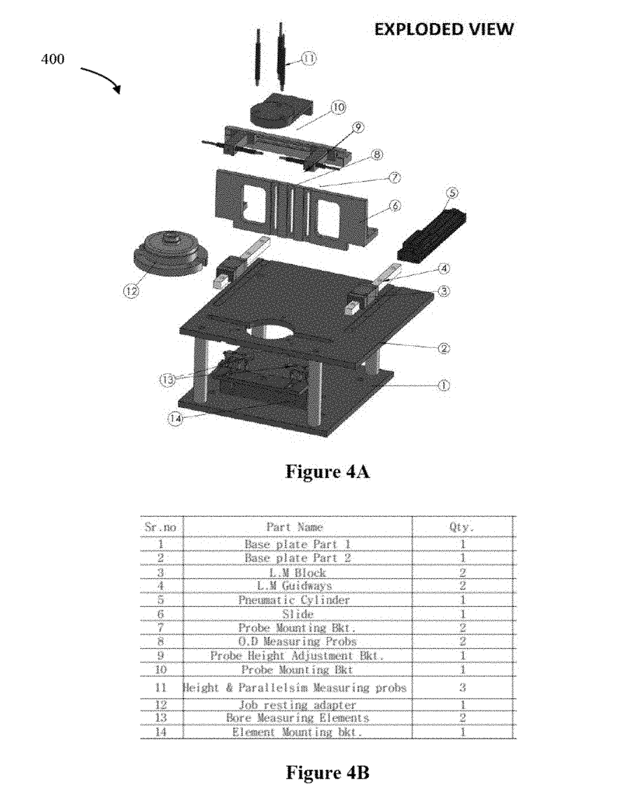

FIG. 4A and FIG. 4B shows an exploded view of the gauging station in accordance with an embodiment of the invention. The gauging station 400 as indicated in FIG. 4A includes 2 base plates (1, 2) that act as a holding base structure for the ganging station 400. The gauging station further includes two Linear Motion (LM) Blocks (3) containing small recirculating bearing balls which move linearly along rails and recirculate within the linear motion block and connect with the two Linear Motion (LM) Guideways (4). The gauging station 400 further includes a slide (5) and probe mounting brackets (7, 10) for mounting the probes. The gauging station 400 primarily includes two outer diameter (O.D) measuring probes (8), three height and parallelism measuring probes (11). The gauging station 400 is farther provided with a probe height adjustment bracket (9) for varying/adjusting the height of the probes. A job resting adapter (12) is provided for placing/holding the job. The gauging station 400 further includes two bore measuring elements (13) and an element mounting bracket (14). The work piece to be tested is placed on the job resting adapter and the various dimensions are measured with the help of various probes including outer diameter measuring probes, height and parallelism measuring probes. The details of the part numbers along with then quantity are indicated in the FIG. 4B. The ganging station 400 is generally placed on an electrical and pneumatic panel as can be seen in the following figures.

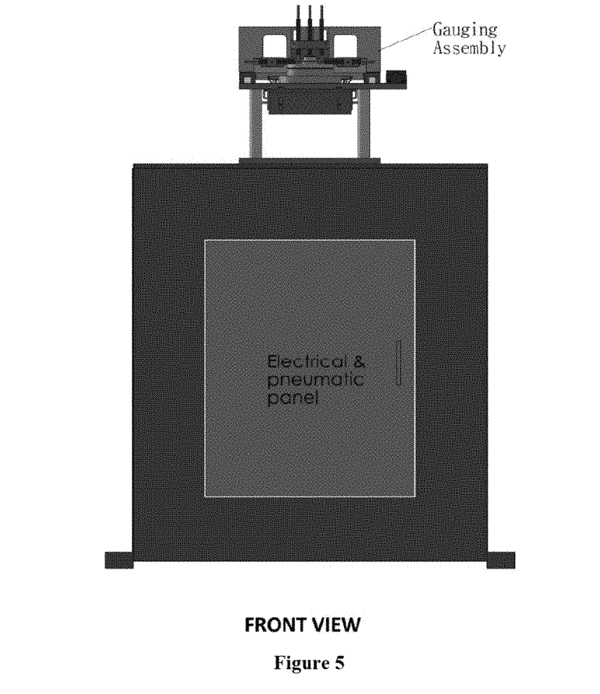

FIG. 5 shows the front view of the gauging station as shown in FIG. 4A in accordance with an embodiment of the invention.

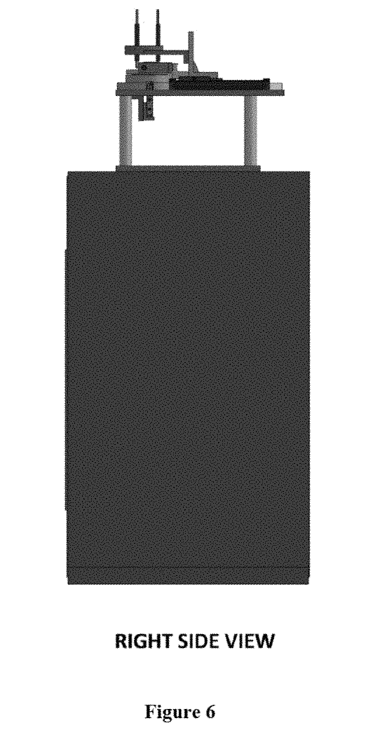

FIG. 6 shows the right side view of the gauging station as shown in FIG. 4A in accordance with an embodiment of the invention;

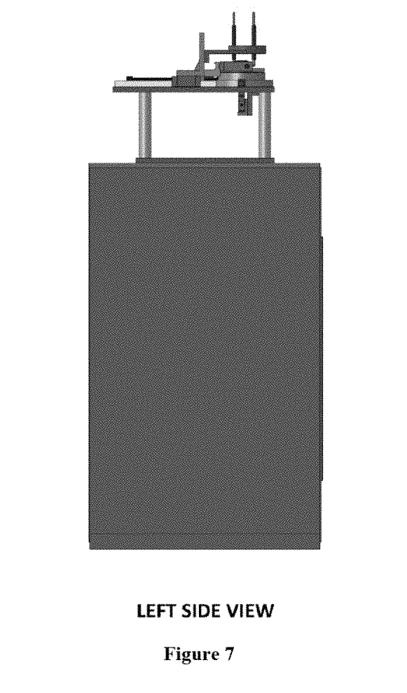

FIG. 7 shows the left side view of the gauging station as shown in FIG. 4A in accordance with an embodiment of the invention.

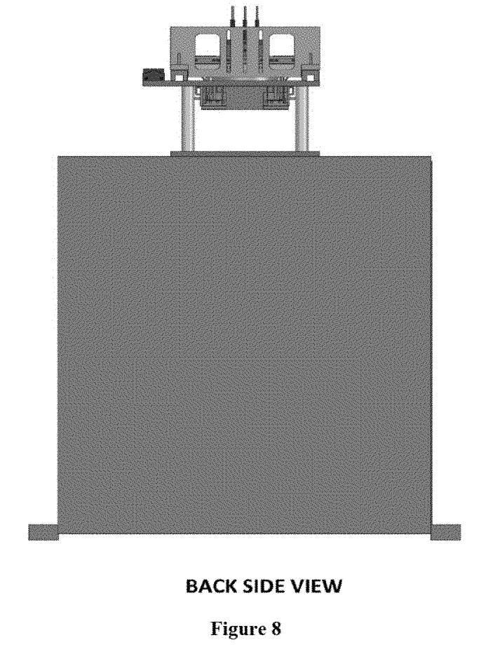

FIG. 8 shows the back side view of the gauging station as shown in FIG. 4A in accordance with an embodiment of the invention.

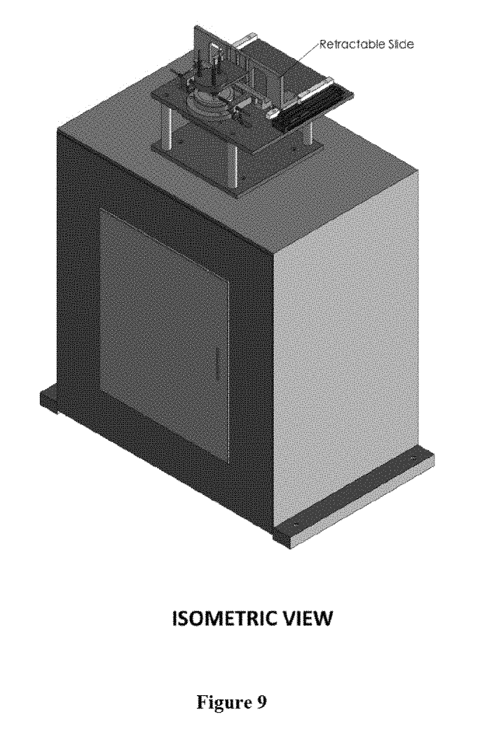

FIG. 9 shows the isometric view of the gauging station as shown in FIG. 4A in accordance with an embodiment of the invention.

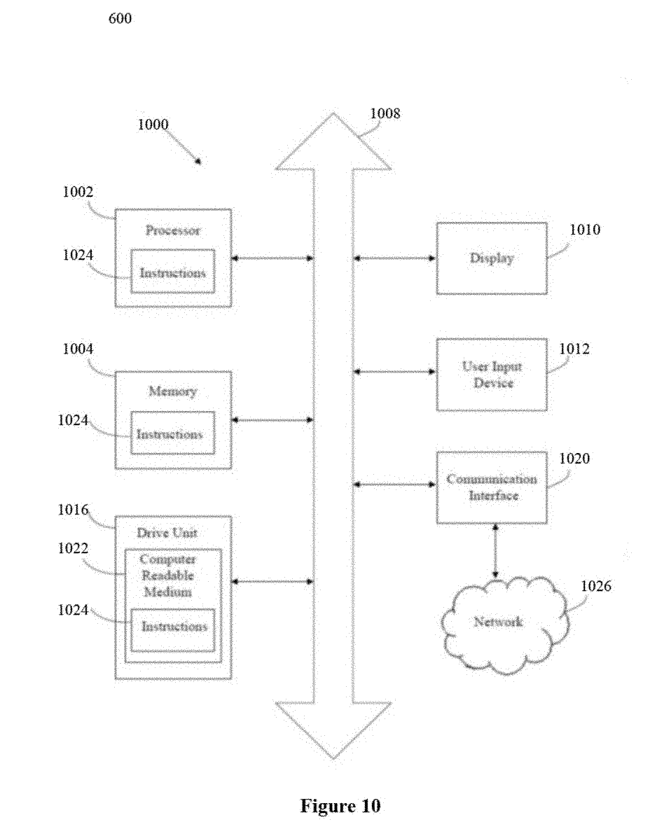

Referring to FIG. 10, a typical hardware configuration of a computer system, which is representative of a hardware environment for practicing the present invention, is illustrated. The computer system 1000 can include a set of instructions that can be executed to cause the computer system 1000 to perform any one or more of the methods disclosed. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single computer system 1000 is illustrated, the term “system” shall also be taken to include any collection of systems or sub-systems that individually or jointly execute a set, or multiple sets, of instructions to perform one or more computer functions.

The computer system 1000 may include a processor 1002 e.g., a central processing unit (CPU), a graphics processing unit (GPU), or both. The processor 1002 may be a component in a variety of systems. For example, the processor may be part of a standard personal computer or a workstation. The processor 1002 may be one or more general processors, digital signal processors, application specific integrated circuits, field programmable gate arrays, servers, networks, digital circuits. analog circuits, combinations thereof, or other now known or later developed devices for analysing and processing data. The processor 1002 may implement a software program, such as code generated manually (i.e., programmed).

The computer system 1000 may include a memory 1004, such as a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 1004 includes a cache or random access memory for the processor 1002. In alternative examples, the memory 1004 is separate from the processor 1002. such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may or may not further include a display unit 1010, such as a liquid crystal display (LCD), an organic light emitting diode (OLED), a flat panel display, a solid state display, a cathode ray tube (CRT), a projector, a printer or other now known or later developed display device for outputting determined information. The display 1010 may act as an interface for the user to see the functioning of the processor 1002, or specifically as an interface with the software stored in the memory 1004 or in the drive unit 1016.

Additionally, the computer system 1000 may include an input device 1012 configured to allow a user to interact with any of the components of system 1000. The input device 1012 may be a number pad, a keyboard, or a cursor control device, such as a mouse or a joystick, touch screen display, remote control or any other device operative to interact with the computer system 1000.

The computer system 1000 may also include a disk or optical drive unit 1016. The disk drive unit 616 may include a computer-readable medium 1022 in which one or more sets of instructions 1024, e.g. software, can be embedded. Further, the instructions 1024 may embody one or more of the methods or logic as described. In a particular example, the instructions 1024 may reside completely, or at least partially, within the memory 1004 or within the processor 1002 during execution by the computer system 1000. The memory 1004 and the processor 1002 also may include computer-readable media as discussed above.

The present invention contemplates a computer-readable medium that includes instructions 1024 or receives and executes instructions 1024 responsive to a propagated signal so that a device connected to a network 1026 can communicate: voice, video, audio, images or any other data over the network 1026. Further, the instructions 1024 may be transmitted or received over the network 1026 via a communication port or interface 1020 or using a bus 1008. The communication port or interface 1020 may be a part of the processor 1002 or may be a separate component. The communication port 1020 may be created in software or may be a physical connection in hardware. The communication port 1020 may be configured to connect with a network 1026, external media, the display 1010, or any other components in system 1000 or combinations thereof. The connection with the network 1026 may be a physical connection, such as a wired Ethernet connection or may be established wirelessly as discussed later. Likewise, the additional connections with other components of the system 1000 may be physical connections or may be established wirelessly. The network 1026 may alternatively be directly connected to the bus 1008.

The network 1026 may include wired networks, wireless networks, Ethernet AVB networks, or combinations thereof. The wireless network may be a cellular telephone network, an 802.11 802.16, 802.20, 802.1Q or WiMax network. Further, the network 1026 may be a public network, such as the Internet, a private network, such as an intranet, or combinations thereof, and may utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the system 1000.

Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. A method for gauging and auto correcting geometric tolerances in respect of a work piece, said method comprising:
receiving one or more desired/standard geometric tolerance values in respect of a first work piece from a user;
storing said one or more desired/standard geometric tolerances values respect of the first work piece;
measuring one or more geometric tolerance values in respect of a second work piece;
comparing the measured one or more geometric tolerance values in respect of the second work piece with the corresponding stored one or more desired/standard geometric tolerance values;
assessing existence of a deviation/variation in said one or more geometric tolerance values measured in respect of the second work piece within a predetermined tolerance range based on comparison; and
auto-correcting one or more geometric tolerance values in respect of the second work piece based on identified deviation/variation in the event of existence of a deviation/variation within the predetermined tolerance range in said one or more geometric tolerance values in respect of the second work piece based on comparison,
such that the corrected one or more geometric tolerance values in respect of the second work piece is equivalent to stored one or more desired/standard geometric tolerances.

2. The method as claimed in claim 1 further comprising sending a signal to the user in the event of existence of deviation/variation beyond said predetermined tolerance range in said one or more geometric tolerance values measured in respect of the second work piece.

3. The method as claimed in claim 1, wherein said one or more desired/standard geometric tolerance values are calculated by measuring and calculating a mean of geometric tolerance values associated with a plurality of similar first work pieces,

4. The method as claimed in claim 1 further comprising calculating the correction value to be applied to one or more geometric tolerance values in respect of the second work piece based on identified deviation/variation.

5. The method as claimed in claim 1, wherein the predetermined tolerance range of deviation/variation is pre-stored and configured to be modified by the user.

6. The method as claimed in claim 1, wherein the geometric tolerance values include values relating to one or more of outer diameter, inner diameter, height, size, cross-sectional area, thread pitch, of in respect of work piece. (Any other the inventors may provide).

7. The method as claimed in claim 1 further comprising storing in the memory and displaying on a display one or more of:
a. the measured one or more geometric tolerance values in respect of the first second work piece;
b. results of comparison of the measured one or more geometric tolerance values in respect of the second work piece with the corresponding stored one or more desired/standard geometric tolerance values;
c. the correction value to be applied to one or more geometric tolerance values in respect of the second work piece based on identified deviation variation.
d. log details pertaining to the measurement and comparison.

8. An system connected to a CNC machine for gauging and auto correcting geometric tolerances in respect of a work piece, said system comprising:
an input means for receiving one or more desired/standard geometric tolerance values in respect of a first work piece from a user:
a memory for storing said one or more desired/standard geometric tolerances values in respect of the first work piece;
a processor, in operational interconnection with one or more probes, configured for:
measuring one or more geometric tolerance values in respect of a second work piece;
comparing the measured one or more geometric tolerance values in respect of the second work piece with the corresponding stored one or more desired/standard geometric tolerance values;
assessing existence of a deviation/variation within a predetermined tolerance range in said one or more geometric tolerance values measured in respect of the second work piece based on comparison: and
a correction unit for auto-correcting one or more geometric tolerance values in respect of the second work piece based on identified deviation/variation in the event of existence of a deviation/variation in within a predetermined tolerance range in said one or more geometric tolerance values in respect of the second work piece based on comparison,
such that corrected one or more geometric tolerance values in respect of the second work piece is equivalent to stored one or more desired/standard geometric tolerances.

9. The system as claimed in claim in claim 8, wherein said one or more probes include touch probes and digital probes including lasers.

10. The system as claimed in claim in claim 8 further including one or more sensors to sense placement of correct work piece on the system.
